(19) United States
(12) Patent Application Publication
(10) Pub. No.: US 2004/0208982 A1
(43) Pub. Date: Oct. 21, 2004

(54) Snack product coated with carbonated candy granules and the process for preparing the same

(76) Inventor: Jeong-Min Yoon, Anyang-si (KR)

Correspondence Address: Anderson, Kill & Olick, P.C., 1251 Avenue of the Americas, New York, NY, 10020, US

(21) Appl. No.: 10/418,897

(22) Filed: Apr. 17, 2003

(51) Int. Cl. A23G 1/00

(52) U.S. Cl. 426/660

(57) ABSTRACT

The present invention relates to a snack product coated with carbonated candy granules and the process for preparing the same. The snack product of the present invention is characterized by the use of chocolate syrup as a medium to adhere carbonate candy granules to a snack substrate. By evenly coating the chocolate syrup onto the snack substrate and then adhering carbonated candies thereon, the snack product keeps an excellent popping effect of carbonate candies for a long time.

### FIELD OF THE INVENTION

The present invention relates to a snack product coated with carbonated candy granules and the process for preparing the same. More particularly, the present invention relates to a snack product coated with carbonated candy by using chocolate syrup as a medium, and the process for preparing the same.

Carbonated candy (also called “popping candy” or “crackling candy”), which is prepared by injecting carbonic acid gas into candy, is still popular with consumers throughout the world more than ten years after it has been developed, due to its characteristics of inducing a sizzling or popping sensation in the mouth. Therefore, many kinds of applied products utilizing carbonated candy have been developed, for example, a product mixed with the powder for a drink, a product to dip a lollipop into a powder prepared by mixing acid and fine sugar with carbonated candy granules. However, it is difficult to coat carbonated candy granules onto a snack product without reducing the popping effect of the carbonated candy. For this reason, a snack product coated with carbonated candy granules has not been developed until now.

The present inventor has developed a snack product, which is evenly coated with carbonated candy granules and keeps the maximum popping effect after manufacture, by using chocolate syrup having low content of water as a medium for adhering carbonated candy to the snack.

### SUMMARY OF THE INVENTION

It is a feature of the present invention to provide a snack product coated with carbonated candy granules to improve its commercial value.

Another feature of the present invention is to provide a snack product coated with carbonated candy granules which is capable of providing a soft snack product with the sizzling and popping sensation of carbonated candy, and a cool and refreshing feeling when the snack product coated with carbonated candy granules is put in the mouth.

Yet another feature of the present invention is to provide the optimal process conditions capable of evenly coating carbonated candy granules onto a snack.

The said and other objects can be achieved according to the present invention illustrated below.

### DETAILED DESCRIPTION OF THE INVENTION

The present invention relates to a snack product coated with carbonated candy granules and the process for preparing the same.

According to the present invention, a snack product coated with carbonated candy granules is produced by using the chocolate syrup, wherein the chocolate syrup has preferably about 1 to 3% by weight of water and viscosity of about 20 to 80 poises, and the size of the carbonated candy granules is preferably about 6 to 14 meshes.

The basic process for preparing the snack product is comprised of the following steps:

mixing the raw materials for a snack substrate and baking the mixture at a temperature of 130 to 200° C. to produce a snack substrate, and then cooling the said snack substrate;

mixing 100 parts by weight of the snack substrate and 10 to 50 parts by weight of a chocolate syrup having a temperature of 35 to 45° C. to coat said snack substrate with the chocolate syrup; and

adding 10 to 60 parts by weight of the carbonated candy granules to 100 parts by weight of the resulting snack substrate coated with the chocolate syrup and then cooling the mixture.

In the above process, the temperature of the chocolate syrup is 35 to 45° C. when it is mixed with the snack substrate, but its temperature drops to 30 to 35° C. when about 80 to 90% of the mixing process is complete. At this time, it is most preferable to add the carbonated candy granules to the snack substrate. At this point, carbonated candies are attached to the surface of snack substrate with the maximum adhesive force by coating them with chocolate syrup. In this way, the popping effect of the carbonated candy granules is maintained.

According to the present invention, the size of the carbonated candy granules is preferably 6 to 14 meshes to attach onto the snack with an optimum state. A specific process for preparing carbonated candy is disclosed in the U.S. Pat. No. 5,439,698.

According to the present invention, chocolate syrup is used as a medium to adhere the carbonated candy to the surface of snack substrate. When conventional corn syrup or liquid syrup is used as a medium to adhere the carbonated candy to the surface of snack substrate, the carbonated candy granules begin to melt immediately after contacting with the syrup since the water content of the syrup is more than 10%. Therefore, the popping effect of the carbonated candy granule is decreased when it is taken. In addition, edible powders such as starch or wheat flour cannot be used despite having their low content of water, because of their low adhesive qualities.

Therefore, in the present invention, the carbonated candy is coated on the surface of the snack by using chocolate syrup, which has a low content of water. According to the present invention, the popping effect of carbonated candy may not be reduced because the chocolate syrup has a low content of water of 1 to 3% by weight and high content of fat of more than 20% by weight. Hence, chocolate syrup is the most preferable medium for coating the snack substrate with carbonated candy granules.

In addition, the present invention provides optimum conditions for coating the snack substrate with carbonated candy granules. Although the chocolate syrup is used as a medium, maximum effects cannot be achieved without satisfying certain conditions such as the kind of oil used as a raw material of the syrup and processing conditions (for example, the point of time to add the chocolate syrup, viscosity and temperature of the chocolate syrup, the input of the chocolate syrup, the point of time to add carbonated candy, and the size of carbonated candy granules). Namely, if said conditions are not satisfied, either carbonated candy granules may be easily dropped or the popping effect of carbonated candy granules, which are susceptible to the external humidity, may be decreased, thereby resulting in deterioration of the commercial value of the product.

Furthermore, carbonated candy granules should be coated evenly at any surface of the snack, and the carbonated candy granule itself should not be affected by the external humidity to stably adhere to the snack. To evenly adhere carbonated candy granules to the surface of snack regardless of the shape of the snack, the whole snack substrate should be evenly coated with chocolate syrup. At the same time, the carbonated candy itself is also coated completely and evenly with chocolate syrup so that the carbonated candy granules are not susceptible to the external humidity.

For the above purpose, typically a tumbler is used as a reactor, which is a type of a cylindrical tube having a round-shaped projecting part to facilitate the tumble of each component. The snack substrate is put into the rotating tumbler, and the chocolate syrup having proper viscosity and temperature is simultaneously added through a separate pipe. Also, carbonated candy granules are put into the tumbler through a separate hopper at a proper time, and then mixed. Finally, the mixture is released from the tumbler.

If the mixture is quenched (cooled), the adhesive strength of the carbonated candy granules is enhanced. As a result, the carbonated candy granules are not easily separated from the snack. If the cooling process is not sufficiently carried out, the oily granules of chocolate are not stable and the quality of the carbonated candy is reduced. Therefore, the cooling process should be carried out sufficiently at a proper temperature (about 20 to 25° C.) and humidity (about 30 to 60%) for a short time (about 1 to 5 minutes). The cooling time may be changed depending on the manufacturing scale, and may be easily determined by those skilled in the art.

A preferred embodiment for preparing a snack according to the present invention is described below.

Various shapes of the snack substrate are prepared by using an extruder, a manufacturing device for the snack substrate. The raw materials and their contents for preparing the snack substrate, and conventional process for preparing the snack substrate are well known by those skilled in the art.

The water content of the snack substrate is in general decreased from about 5 to 10% to about 1 to 3% when it is passed through the oven, causing the snack substrate to become crispy. The general snack product is prepared by adding various flavors to the said snack substrate. The snack product according to the present invention is prepared by adhering carbonated candy granules to the snack substrate to enhance its commercial value.

The snack substrate is transferred to the hopper at a temperature of 25 to 35° C. and humidity of 30 to 60%, and then cooled down to maintain the stable quality of the snack substrate. The temperature of the snack substrate is kept constant, and then it is put into the tumbler (its internal temperature of about 25 to 35° C.) rotating at 15 to 30 times per minute.

The chocolate syrup, of which viscosity is about 20 to 80 poise and temperature is about 35 to 45° C., is mixed with the snack substrates falling into the tumbler in an amount of 10 to 50 parts by weight per 100 parts by weight of snack substrate, whereby rotating the snack substrate are coated with chocolate syrup by rotation of the tumbler. When the snack substrate is transferred to about 80 to 90% of the full length of the rotating tumbler, the snack substrate is completely coated with the chocolate syrup. At this moment, the carbonated candy granules are put into the tumbler to adhere to the chocolate syrup-coated snack. The amount of the carbonated candy granules required depends on the degree of chocolate coating and the degree of popping desired. 10 to 60 parts by weight of carbonated candy granules are usually added based on 100 parts by weight of the chocolate-coated snack.

The carbonated candy granules themselves are also coated with chocolate syrup by rotation of the tumbler, whereby the decrease of the popping effect of carbonated candy by the change of external humidity may be prevented.

The chocolate syrup should keep a high adhesive strength when carbonated candy is added to the tumbler. At this time, preferably the temperature of the chocolate syrup is about 30 to 35° C. If the temperature of the chocolate syrup is higher than 35° C., the viscosity of chocolate syrup becomes low, and the carbonated candy granules may be easily separated by rotation of the tumbler. If the temperature of the chocolate syrup is lower than 30° C., the chocolate syrup becomes hard and the carbonated candy cannot be easily adhered to the surface of the snack.

Any conventional chocolate syrup having a melting point of about 30 to 35° C. may be used. When selecting the chocolate syrup, it is important to select vegetable oil (for example, coconut oil, palm oil, corn oil, and the like) as a raw material of the chocolate syrup, because the coating process is not complete if the melting point of the oil component is too high or too low. Therefore, hydrogenated vegetable oil, which has a melting point of about 30 to 35° C., is preferable as oil for chocolate, because when the temperature of chocolate is cooled down below 30° C. in the cooling step, it will be quickly hardened and thus will be stabilized. Other raw materials for preparing the chocolate syrup are the same with those of the conventional chocolate syrup such as sugar, cacao powder, milk powder, emulsifier, flavor, and so on.

The particle size of the carbonated candy granules of about 6 to 14 mesh (Tyler mesh: 3.350 to 1.180 mm) is preferable for a good adhesive strength and a good popping effect.

After the carbonated candy granules adhere to the chocolate-coated snack and come out through the tumbler, the carbonated candy granules will be cooled down. At the cooling step, a snack coated with the carbonated candy granules is passed through a conveyor belt vibrating for 1 to 2 minutes at a temperature of about 20 to 25° C., and humidity of about 30 to 60%. In this process, a lump of carbonated candy granules is evenly dispersed. The snack substrate is passed subsequently through the cooling belt at a temperature of 5 to 15° C., and then the cooling step is completed.

It is the final step to pack the products. Temperature of 15˜25° C. and humidity of 30˜55% in a packing room is preferable. The above conditions are ideal to stabilize oil in the chocolate syrup and the carbonated candy granules, regardless of external humidity.

### PREFERRED EMBODIMENT OF THE INVENTION

Snack substrates were prepared by mixing 50 g of corn granules, 50 g of rice granules and 2 g of calcium carbonate and the mixture was baked at 150° C., and the resulting snack substrates were cooled to 25° C. under humidity of 50%. 100 g of the above snack substrates were transferred into a hopper at a temperature of 25° C. and humidity of 30%, and once the temperature of the snack substrates became constant, the snack substrates were put into the tumbler (internal temperature of 25° C.) rotating 20 times per minute. 20 g of the chocolate syrup at a temperature of 35° C. and viscosity of 40 poise were injected into the tumbler to coat onto the snack substrate. When the snack substrate was transferred to 80% of the full length of the tumbler, 60 g of carbonated candy granules were added and the internal temperature of the tumbler was maintained at 25° C. Carbonated candy granules of 8 meshes were used.

After the chocolate-coated snack substrate covered with the carbonated candy granules was passed through the tumbler, it was passed through the vibrating conveyor belt for 1˜2 minutes. When lumps of the carbonated candy granules on the snack substrate were dispersed, the snack substrate was passed through the cooling belt at a temperature of 10° C. and then the cooling step was completed.

After the cooling step was completed, the chocolate-coated snack covered with the carbonated candy granules was obtained.

The popping effect of the carbonated candy can be known by the content of gas thereof. If gas content based on 15 g of carbonated candy granules is 30˜40 cc when carbonated candy granules of 6˜14 meshes are used, it is generally called that carbonated candy granules have a good popping effect. To evaluate the popping effect of the carbonated candy granules of the resulting chocolate-coated snack, their gas content was measured. The carbonated candy granules of the resulting chocolate-coated snack have 40 cc of gas content per 15 g of carbonated candy granules, and even after storing the snack for 24 hours at a temperature of 20° C. and humidity of 30%, the gas content of the snack was unchanged as 40 cc. Therefore, it is concluded that the popping effect of the carbonated candy granules of the chocolate-coated snack is not reduced, and very little carbonated candy falls off the snack.

In the present invention, chocolate syrup is used as a medium to stably adhere the carbonated candy granules to a snack substrate, and the optimal process conditions for keeping the highest adhesive strength and the popping effect of the carbonated candy for a long time are provided. According to the present invention, a snack product coated with carbonated candy granules, which has not been developed until now due to the problem of adherence of the carbonated candy granules or the decrease of popping effect of carbonated candy after adherence, can be obtained.

1. A snack product coated with the carbonated candy granules prepared by using chocolate syrup as a medium of coating.

2. The snack product according to claim 1, wherein said chocolate syrup has a content of water of 1 to 3% by weight and viscosity of 20 to 80 poise, and it comprises hydrogenated vegetable oil having a melting point of 30 to 35° C.

3. The snack product according to claim 1, wherein said carbonated candy granules have the particle size of 6 to 14 meshes and the carbonated candy granules themselves are further coated with the chocolate syrup.

4. A process for preparing a snack product wherein said product is coated with chocolate syrup and carbonated candy granules are adhered thereon, comprising the steps of:
mixing the raw materials for a snack substrate and baking the mixture at a temperature of 130 to 200° C. to produce a snack substrate, and then cooling the said snack substrate;
mixing 100 parts by weight of the snack substrate and 10 to 50 parts by weight of a chocolate syrup having a temperature of 35 to 45° C. to coat said snack substrate with the chocolate syrup; and
adding 10 to 60 parts by weight of the carbonated candy granules to 100 parts by weight of the resulting snack substrate coated with the chocolate syrup and then cooling the mixture.

5. The process according to claim 4, wherein the particle size of the carbonated candy granules is 6 to 14 meshes.
